(19) United States
(12) Patent Application Publication
(10) Pub. No.: US 2025/0269583 A1
(43) Pub. Date: Aug. 28, 2025

(54) 3D PRINTED FURNITURE WITH CAPTURED COMPONENTS AND METHOD OF MAKING THE SAME

(71) Applicant: Haddy, Inc., St. Petersburg, FL (US)

(72) Inventors: Kyle Rowe, St. Petersburg, FL (US); Dylan Hoskins, St. Petersburg, FL (US); John Rogers, St. Petersburg, FL (US); Jonathan Miller, St. Petersburg, FL (US); Numa Pailhol, St. Petersburg, FL (US)

(21) Appl. No.: 19/065,707

(22) Filed: Feb. 27, 2025

Related U.S. Application Data
(60) Provisional application No. 63/558,725, filed on Feb. 28, 2024.

(51) Int. Cl. B29C 64/106; B29C 64/188; B29C 64/30; B29L 31/34; B29L 31/44; B33Y 10/00; B33Y 40/20; B33Y 80/00

(52) U.S. Cl. CPC B29C 64/106; B29C 64/188; B29C 64/30; B33Y 10/00; B33Y 40/20; B33Y 80/00; B29L 2031/3481; B29L 2031/44

(57) ABSTRACT

A three-dimensional (3D) printed multi-component structure includes a first component and a second component. The second component is formed to define a cavity that extends into the second component. The first component is located in the cavity of the second component to at least partially embed the first component in the second component.

### CROSS REFERENCE TO RELATED APPLICATIONS

This application claims priority to and the benefit of U.S. Provisional Patent Application Number 63/558,725, filed 28 Feb. 2024, the disclosure of which is now expressly incorporated herein by reference.

### FIELD OF THE DISCLOSURE

The present disclosure relates generally to furniture, and more specifically to 3D printed furniture with captured components and methods of the making the same.

### BACKGROUND

Disposing of some objects, such as furniture or décor, may be difficult. Furniture waste is becoming increasingly problematic as furniture is generally made of multiple different materials, many of which are difficult to recycle. Further, taking apart furniture to process each type of material separately is time-consuming and expensive.

Three-dimensional (3D) printing may be used to make three-dimensional objects. 3D printing is achieved using additive processes during which an object is created by laying down successive layers of material until the object is created. There remains interest in using 3D printing to reduce furniture waste.

### SUMMARY

The present disclosure may comprise one or more of the following features and combinations thereof.

A method of three-dimensional (3D) printing multi-component furniture may comprise providing a first furniture component. The method may comprise depositing at least one first layer of molten material on a print surface to form a first side of a second furniture component. The method may comprise depositing at least one second layer of molten material onto the at least one first layer of molten material while the at least one first layer of molten material is molten to form a body of the second furniture component having a cavity. The method may comprise inserting the first furniture component into the cavity of the second furniture component. The method may comprise depositing at least one third layer of molten material onto the at least one second layer of molten material and the first furniture component while the at least one second layer of molten material is molten to form a second side of the second furniture component. The method may comprise cooling the at least one first layer of molten material, the at least one second layer of molten material, and the at least one third layer of molten material to cause the at least one first layer of molten material, the at least one second layer of molten material, and the at least one third layer of molten material to solidify and form the second furniture component having the first furniture component at least partially encapsulated therein.

In some embodiments, depositing at least one third layer of molten material onto the at least one second layer of molten material and the first furniture component may include depositing the at least one third layer of molten material on a perimeter of the first furniture component so that the first furniture component is captured in the second furniture component by the at least one third layer of molten material and at least a portion of the first furniture component is accessible from an exterior of the second furniture component. Depositing at least one third layer of molten material onto the at least one second layer of molten material and the first furniture component may include depositing the at least one third layer of molten material on an entirety of the first furniture component so that the first furniture component is entirely encapsulated in the second furniture component by the at least one third layer of molten material.

In some embodiments, the first furniture component may not be accessible from an exterior of the second furniture component. The method may further comprise, after the step of cooling, removing material from the second side of the second furniture component located above the first furniture component to form an opening in the second side of the second furniture component so that the first furniture component is accessible from an exterior of the second furniture component. Removing material from the second side of the second furniture component may include milling the material from the second side of the second furniture component.

In some embodiments, the method may further comprise providing a metal plate. The method may further comprise, after the step of depositing at least one first layer of molten material on a print surface and before the step of depositing at least one second layer of molten material onto the at least one first layer of molten material, locating the metal plate on the at least one first layer of molten material and depositing at least one fourth layer of molten material on the at least one first layer of molten material and the metal plate. The method may further comprise, after the step of cooling, heating the metal plate to cause the solidified at least one third layer of molten material and the solidified at least one fourth layer of molten material located on the metal plate to become molten.

In some embodiments, the method may further comprise removing the metal plate and the first furniture component from the second furniture component. The first furniture component may include an RFID chip or a NFC chip. The first furniture component may include a sensor. The method may further comprise 3D printing the first furniture component.

According to another aspect of the present disclosure, a method of three-dimensional (3D) printing a multi-component structure may comprise providing a first component. The method may comprise depositing at least one first layer of molten material to form a first side of a second component. The method may comprise depositing at least one second layer of molten material onto the at least one first layer of molten material while the at least one first layer of molten material is molten to form a body of the second component. The method may comprise positioning the first component on the second component. The method may comprise depositing at least one third layer of molten material onto the first component while the at least one second layer of molten material is molten to form a second side of the second component. The method may comprise cooling the at least one first layer of molten material, the at least one second layer of molten material, and the at least one third layer of molten material to cause the at least one first layer of molten material, the at least one second layer of molten material, and the at least one third layer of molten material to solidify and form the second component having the first component at least partially embedded therein.

In some embodiments, positioning the first component on the second component may include positioning an embedded portion of the first component on top of the body of the second component and positioning an external portion of the first component adjacent to the body of the second component. Depositing at least one third layer of molten material onto the first component may include directing the at least one third layer of molten material through at least one hole formed in the embedded portion of the first component. The external portion of the first component may be formed to include a plurality of ridges that align with the first layer of molten material and the second layer of molten material.

According to another aspect of the present disclosure, a three-dimensional (3D) printed multi-component structure may comprise a first component and a second component. The second component may have a first side and a second side opposite the first side. The second component may be formed to define a cavity that extends into the second component from the second side toward the first side. The second component may be 3D printed and the first component may be located in the cavity of the second component to at least partially embed the first component in the second component.

In some embodiments, the first component may be entirely encapsulated in the second component. The first component may comprise a RFID chip, a NFC chip, or a sensor.

### BRIEF DESCRIPTION OF THE DRAWINGS

The detailed description particularly refers to the accompanying figures in which:

FIG. 1 is a diagrammatic view of a method for three-dimensional (3D) printing a multi-component structure showing that the method includes (i) providing a first furniture component, (ii) setting a print path for a first layer of molten material and depositing the first layer to form a first side of a second furniture component, (iii) setting a print path for a second layer of molten material and depositing the second layer on the first layer, (iv) setting a print path for a third layer of molten material and depositing the third layer on the second layer to form a cavity in the third layer of molten material, (v) inserting the first furniture component into the cavity, and (vi) depositing a fourth layer of molten material on an entirety of the first furniture component and the third layer of molten material to form the second furniture component having the first furniture component encapsulated therein;

FIG. 2 is a diagrammatic view of a method for three-dimensional (3D) printing the multi-component structure showing that the method includes milling an opening in the second furniture component so that the first furniture component is visible;

FIG. 3 is a diagrammatic view of a method for three-dimensional (3D) printing the multi-component structure showing that the method includes providing a metal plate and locating the metal plate on the first layer of molten material so that the metal plate is encapsulated by the second layer of molten material;

FIG. 4 is a diagrammatic view of an alternative method for three-dimensional (3D) printing a multi-component structure showing that the method includes (i) providing a first furniture component, (ii) setting a print path for a first layer of molten material and depositing the first layer to form a first side of a second furniture component, (iii) setting a print path for a second layer of molten material and depositing the second layer on the first layer, (iv) setting a print path for a third layer of molten material and depositing the third layer of molten material on the second layer to form a cavity in the third layer, (v) inserting the first furniture component into the cavity, and (vi) depositing a fourth layer of molten material on a perimeter of the first furniture component and on the third layer of molten material to form the second furniture component having the first furniture component captured therein;

FIG. 5 is a diagrammatic view of an alternative method for three-dimensional (3D) printing a multi-component structure showing that the method includes (i) providing a first furniture component, (ii) setting a print path for a first layer of molten material and depositing the first layer to form a first side of a second furniture component, (iii) locating the first furniture component on the first layer of molten material, and (vi) depositing a second layer of molten material on a perimeter of the first furniture component and on the first layer of molten material to form the second furniture component having the first furniture component captured therein; and

FIG. 6 is a diagrammatic view of an alternative method for three-dimensional (3D) printing a multi-component structure showing that the method includes (i) providing a first furniture component, (ii) depositing a first layer of molten material to form a first side of a second furniture component and depositing a second layer of molten material on the first layer to form a body of the second furniture component, (iii) locating a portion of the first furniture component on the body of the second furniture component, and (iv) depositing a third layer of molten material on the first furniture component to form the second furniture component having the first furniture component partially embedded therein.

### DETAILED DESCRIPTION

For the purposes of promoting an understanding of the principles of the disclosure, reference will now be made to a number of illustrative embodiments illustrated in the drawings and specific language will be used to describe the same.

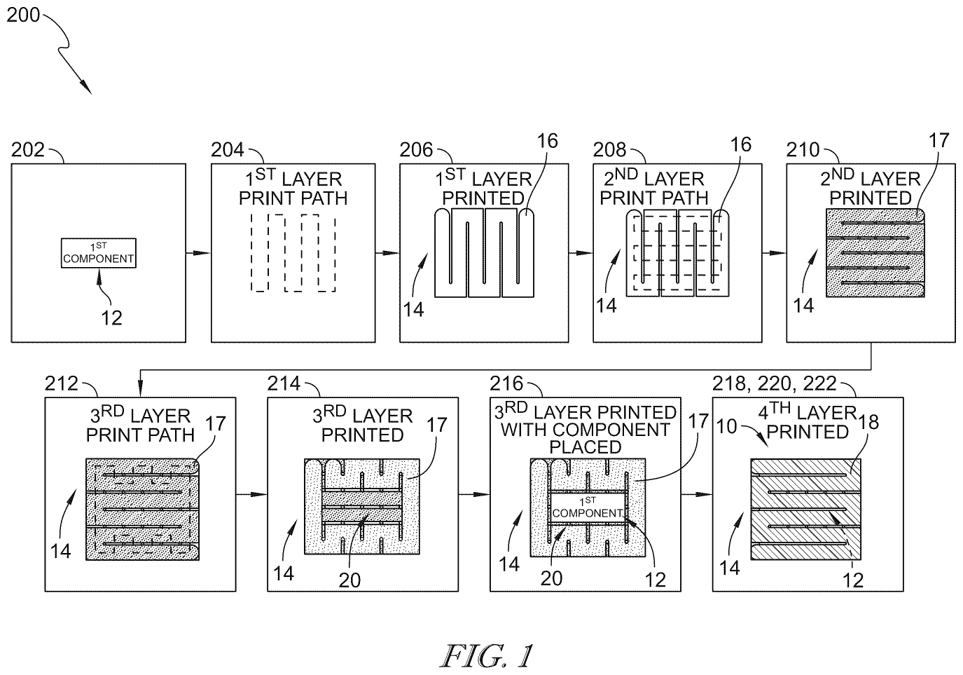

A three-dimensional (3D) printed multi-component structure 10 in accordance with the present disclosure includes a first furniture component 12 and a second furniture component 14, as shown in FIGS. 1-3. The first furniture component 12 may be captured by or embedded in the second furniture component 14 without using adhesives and/or fasteners, such as glue, bolts, screws, rivets, nails, or other similar adhesives or fasteners. Instead, the first furniture component 12 is inserted into the second furniture component 14 while the second furniture component 14 is being 3D printed so that the first furniture component 12 is captured by or embedded in the second furniture component 14 during the printing process. The absence of adhesives and/or fasteners allows for direct recycling of the second furniture component 14 after removal of the first furniture component 12, for example, at an end of life of the multi-component structure 10.

The first furniture component 12 may provide functionality and/or aesthetic appeal to the second furniture component 14. In illustrative embodiments, the first furniture component 12 is an object or a plurality of objects that is captured by or embedded in the second furniture component 14. In some embodiments, the first furniture component 12 is 3D printed. In some embodiments, the first furniture component 12 is not 3D printed.

The second furniture component 14 includes a first side 16, a second side 18 opposite the first side 16, and a body 17 extending between the first side 16 and the second side 18, as shown in FIG. 1. The first furniture component 12 is located between the first side 16 and the second side 18 of the second furniture component 14. The second furniture component 14 is formed to define a cavity 20 that extends into the body 17 toward the first side 16. The first furniture component 12 is positioned in the cavity 20.

In illustrative embodiments, the second furniture component 14 is 3D printed. The second furniture component 14 may be formed as, for example, a table, a table base, a bench, a chair, a couch, a planter, a desk, a cubicle, a wall or table decoration, or a frame, among other furniture items.

The first furniture component 12 may comprise an active and/or interactive component configured to return feedback to a user of the multi-component structure 10 or to interact with the user of the multi-component structure 10. The first furniture component 12 may be an electronic component. For example, the first furniture component 12 may comprise an NFC chip or an RFID chip that transmits information to the user while the user is in close proximity to the multi-component structure 10. The NFC chip or the RFID chip may be configured to direct the user to a website or an application. The information transmitted to the user may include information such as the history of the material used to create the second furniture component 14, the designer and/or the engineer of the second furniture component 14, the inspiration behind the second furniture component 14, or data regarding other users of the second furniture component 14, among other information.

As another example, the first furniture component 12 may comprise a touch screen device such as a tablet or a remote control for TV, fans, lights, audio systems, or other appliances. As another example, the first furniture component 12 may comprise a remote control including buttons to control TV, fans, lights, audio systems, or other appliances.

The first furniture component 12 may comprise a functional, non-interactive component configured to collect data and/or perform a function for the user of the multi-component structure 10. For example, the first furniture component 12 may comprise a sensor configured to collect and store data. The sensor may comprise a temperature sensor, a proximity sensor, a humidity sensor, a pressure sensor, a force sensor, or any other suitable sensor or combination of sensors. The sensor may collect and store data regarding interactions with the multi-component structure 10, such as, but not limited to, time stamps of when users are interacting with the multi-component structure 10. For example, the sensor may store time stamp data every time a user sits on a bench (i.e., the second furniture component 14).

As an example, the sensor may collect and store weather data, such as temperature data and humidity data. As another example, the sensor may collect and store data related to the health and/or the status of the multi-component structure 10. As an additional example, the sensor may collect and store data related to a location of the multi-component structure 10. The sensor may store the information locally so that the information may be retrieved via a memory card, or the sensor may transmit the information to a remote storage network.

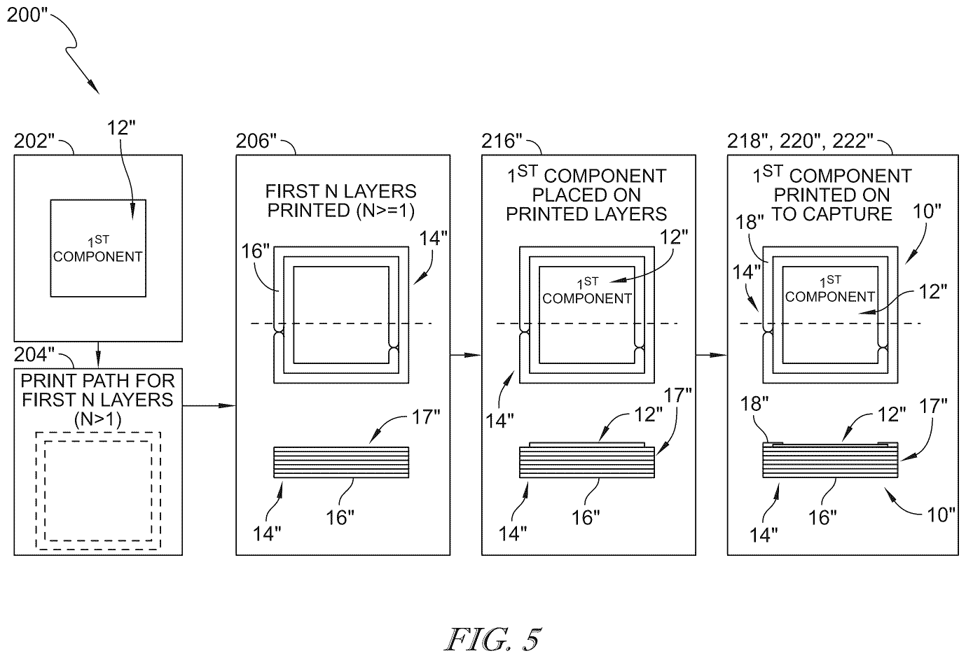

As another example of functional, non-interactive components, the first furniture component 12 may include bearings, hinges, drawers, or other similar components. The first furniture component 12 may include a drain in a planter (i.e., the second furniture component 14). The first furniture component 12 may include a heater in a bench, a chair, or a couch (i.e., the second furniture component 14) to warm the bench, the chair, or the couch. The first furniture component 12 may include a glass window in a window frame (i.e., the second furniture component 14), as shown in FIG. 5. The first furniture component 12 may include a speaker in a speaker box (i.e., the second furniture component 14). The first furniture component 12 may include controls for a motor in a recliner (i.e., the second furniture component 14). The first furniture component 12 may include wiring and/or LEDs for the second furniture component 14. The first furniture component 12 may include one or more USB ports for charging electronics. The first furniture component 12 may include hooks for coats, purses, bags, keys, umbrellas, etc. The first furniture component 12 may include metal mesh to create a stronger second furniture component 14. The first furniture component 12 may include a holder, such as a cup holder.

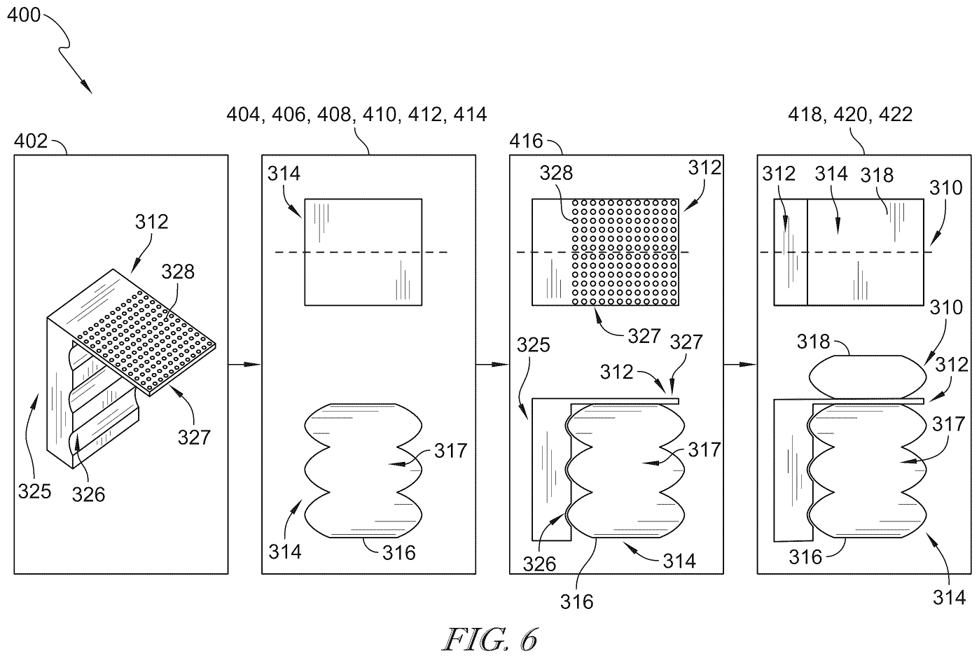

The first furniture component 12 may comprise passive components configured to add aesthetic appeal to the second furniture component 14. For example, the first furniture component 12 may include a placard or a sign, as shown in FIG. 6. As another example, the first furniture component 12 may include a table top, such as a wooden top, a marble top, a metal top, a non-printed polymeric material based top, a ceramic top, a stone top, an engineered materials based top, a polymer top, etc., for a table base (i.e., the second furniture component 14). The first furniture component 12 may include an inlay formed of any material that provides color and/or material contrast from the second furniture component 14.

A method 200 of three-dimensional (3D) printing the multi-component structure 10 is shown in FIGS. 1-3. In step 202, the first furniture component 12 is provided. In step 204, a print path for a nozzle of a printer to deposit at least one first layer of molten material on a print surface is set. In step 206, the at least one first layer of molten material is deposited on the print surface following the print path. The at least one first layer of molten material forms the first side 16 of the second furniture component 14. In step 208, a print path for the nozzle to deposit at least one second layer of molten material on the at least one first layer is set. In some embodiments, the print path for the at least one second layer of molten material is different than the print path for the at least one first layer of molten material, as suggested in FIG. 1.

In step 210, the at least one second layer of molten material is deposited on the at least one first layer of molten material while the at least one first layer of molten material is molten. The at least one second layer of molten material forms a portion of the body 17 of the second furniture component 14.

In step 212, a print path for the nozzle to deposit at least one third layer of molten material on the at least one second layer is set, as shown in FIG. 1. The print path for the at least one third layer of molten material may be different than the print path for the at least one first layer of molten material and/or the print path for the at least one second layer of molten material. The print path for the nozzle in step 212 is based, at least in part, on a shape of the first furniture component 12.

In step 214, the at least one third layer of molten material is deposited on the at least one second layer while the at least one second layer of molten material is molten. The at least one third layer of molten material forms another portion of the body 17 of the second furniture component 14. The print path of the at least one third layer forms the cavity 20 in the body 17 of the second furniture component 14 as the at least one second layer of molten material is not entirely covered by the at least one third layer, as shown in FIG. 1. The cavity 20 may have any shape that allows the first furniture component 12 to be positioned in the cavity 20. It will be understood that any number of layers of molten material may be deposited on top of one another before the cavity 20 is formed, depending, for example, on the desired shape of the second furniture component 14.

In step 216, the first furniture component 12 is inserted into the cavity 20 of the second furniture component 14, as shown in FIG. 1. In step 218, a print path for the nozzle to deposit at least one fourth layer of molten material is set. In step 220, the at least one fourth layer of molten material is deposited onto the at least one third layer of molten material and the first furniture component 12 while the at least one third layer of molten material is molten to form the second side 18 of the second furniture component 14. The at least one fourth layer of molten material bonds to the at least one third layer of molten material to hold the first furniture component 12 in place in the cavity 20. In some embodiments, the at least one fourth layer of molten material covers an entirety of the first furniture component 12 such that the first furniture component 12 is encapsulated in the second furniture component 14 and not visible from an exterior of the second furniture component 14, as shown in FIG. 1.

Any number of layers of molten material may be deposited on top of the first furniture component 12. The number of layers is dependent, at least in part, on the type of the first furniture component 12 and the second furniture component 14. For example, if the first furniture component 12 is an RFID chip, too many layers deposited on top of the RFID chip may interrupt the functionality of the RFID chip.

In step 222, the layers of molten material are cooled to cause the layers of molten material to solidify and form the second furniture component 14 having the first furniture component 12 encapsulated therein, as shown in FIG. 1. As the at least one third layer of molten material cools, the at least one third layer of molten material may shrink around the first furniture component 12 to act as a clamp to hold the first furniture component 12 in place. The at least one second layer and the at least one fourth layer may also act as a clamp to hold the first furniture component 12 in place.

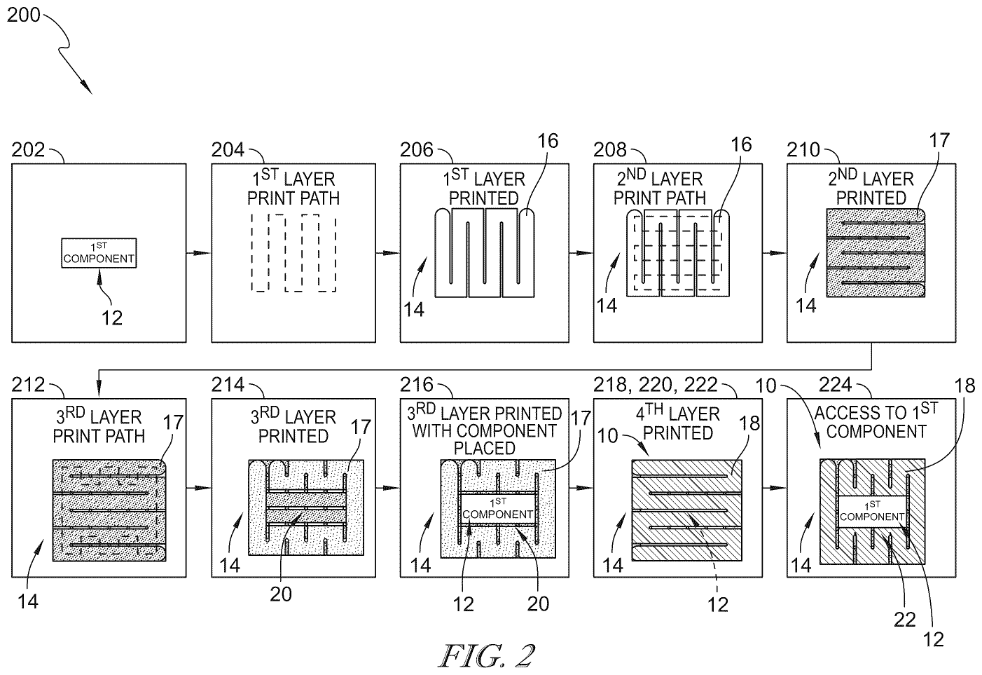

In some embodiments, method 200 further includes step 224 of removing material from the second side 18 of the second furniture component 14 located above the first furniture component 12 to form an opening 22 in the second side 18 of the second furniture component 14, as shown in FIG. 2. The opening 22 provides visibility and/or accessibility of and to the first furniture component 12 from an exterior of the second furniture component 14. In some embodiments, removing the material from the second side 18 of the second furniture component 14 includes milling the material from the second side 18 of the second furniture component 14. In some embodiments, removing the material from the second side 18 of the second furniture component 14 includes turning, drilling, grinding, cutting, lasering, or any other subtractive process.

The opening 22 may be formed if the first furniture component 12 is an electrical component that may require connection via a cable for data transfer. As another example, the opening 22 may be formed if the first furniture component 12 is an inlay and a smooth surface in plane with the inlay is desired. The opening 22 may have any shape such as, for example, a rectangular shape, a circular shape, an irregular shape, among others.

In some embodiments, to recycle the multi-component structure 10, the portion of the second furniture component 14 surrounding the first furniture component 12 is removed so that the first furniture component 12 may be extracted from the second furniture component 14. Removal of the first furniture component 12 from the second furniture component 14 allows for separate discarding of the non-recyclable or dissimilar recyclable material of the first furniture component 12.

In some embodiments, for recycling and/or removal purposes, the portion of the second furniture component 14 surrounding the first furniture component 12 is removed via milling, turning, drilling, grinding, cutting, lasering, or any other subtractive process. In some embodiments, for recycling and/or removal purposes, the portion of the second furniture component 14 surrounding the first furniture component 12 is removed via increasing the temperature of the portion of the second furniture component 14.

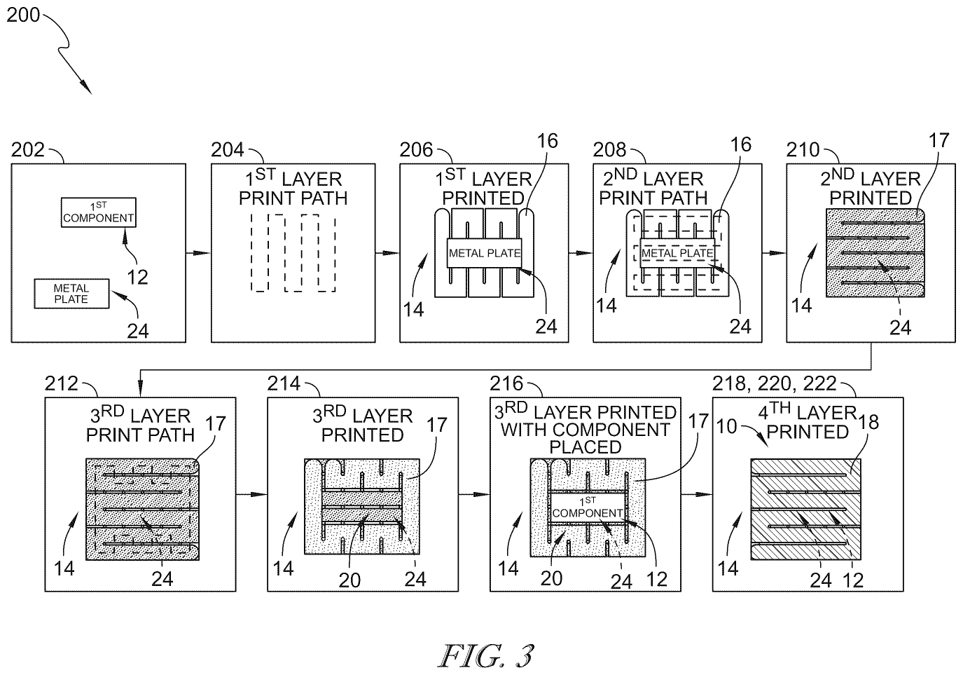

In some embodiments, as shown in FIG. 3, step 202 of method 200 may include providing a metal plate 24. The metal plate 24 may comprise ferrous metal. In step 206, the metal plate 24 may be positioned in or on the at least one first layer of molten material. In step 210, the at least one second layer of molten material may be deposited on top of the at least one first layer of molten material and the metal plate 24 to encapsulate the metal plate 24 therein. In step 214, the cavity 20 formed in the body 17 of the second furniture component 14 may be aligned with the metal plate 24 so that the metal plate 24 is aligned with the first furniture component 12 in step 216 when the first furniture component 12 is inserted into the cavity 20.

For recycling and/or removal purposes of the first furniture component 12, the metal plate 24 is heated, for example, via induction. As an example, an induction coil may be placed near the multi-component structure 10 to heat the metal plate 24. The metal plate 24 may be inductively and separately heated above the melt temperature of the surrounding layers of solidified material of the second furniture component 14 to cause the heat to dissipate to the surrounding layers of material so that the surrounding layers become molten. The metal plate 24 and the first furniture component 12 may then be removed from the second furniture component 14, either manually with a tool or via gravity acting on the metal plate 24, the first furniture component 12, and the surrounding layers of molten material. Alternatively, a resistive heater may be encapsulated in the second furniture component 14 instead of the metal plate 24 and may be used in a similar manner as the metal plate 24 to remove the first furniture component 12.

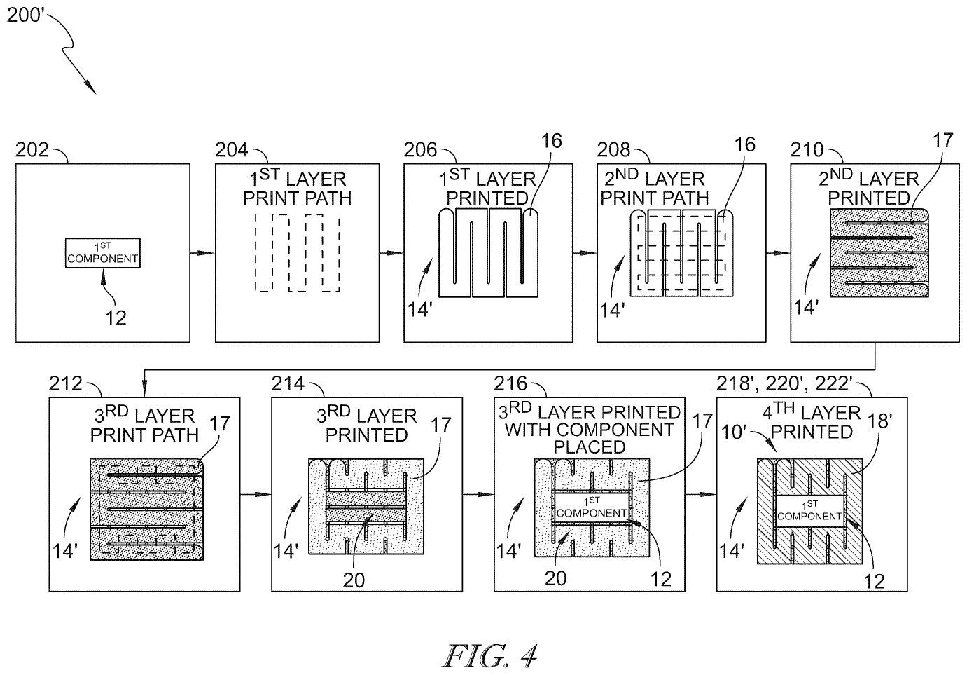

Another method 200′ of three-dimensional (3D) printing a multi-component structure 10′ is shown in FIG. 4. The multi-component structure 10′ is similar to the multi-component structure 10 except for a second side 18′ of a second furniture component 14′, and the method 200′ is similar to the method 200 except for steps 218′ and 220′. In step 202, the first furniture component 12 is provided. In step 204, the print path for the nozzle to deposit the at least one first layer of molten material is set. In step 206, the at least one first layer of molten material is deposited. In step 208, the print path for the nozzle to deposit the at least one second layer of molten material on the at least one first layer is set. In step 210, the at least one second layer of molten material is deposited on the at least one first layer of molten material while the at least one first layer of molten material is molten.

In step 212, the print path for the nozzle to deposit the at least one third layer of molten material on the at least one second layer is set, as shown in FIG. 4. In step 214, the at least one third layer of molten material is deposited on the at least one second layer of molten material. The print path of the at least one third layer of molten material forms the cavity 20 in the body 17 of the second furniture component 14′ as the at least one second layer of molten material is not covered entirely by the at least one third layer of molten material.

In step 216, the first furniture component 12 is inserted into the cavity 20 of the second furniture component 14′, as shown in FIG. 4. In step 218′, a print path for the nozzle to deposit at least one fourth layer of molten material is set. The print path is set so that the at least one fourth layer of molten material is only deposited on a perimeter or a portion of the first furniture component 12. In step 220′, the at least one fourth layer of molten material is deposited onto the at least one third layer of molten material and the portion of the first furniture component 12 while the at least one third layer of molten material is molten to form the second side 18′ of the second furniture component 14′.

The at least one fourth layer of molten material bonds to the at least one third layer of molten material to hold the first furniture component 12 in place, as suggested in FIG. 4. In some embodiments, the at least one fourth layer of molten material only covers the perimeter or a portion of the first furniture component 12 such that the first furniture component 12 is captured in the second furniture component 14′ by the at least one fourth layer of molten material. In such an embodiment, a portion of the first furniture component 12 is visible and/or accessible from an exterior of the second furniture component 14′. In step 222, the layers of molten material are cooled to cause the layers of molten material to solidify and form the second furniture component 14′ having the first furniture component 12 captured therein.

The methods disclosed herein may also be used to at least partially encapsulate the first furniture component 12 after the second furniture component 14 has been 3D printed. For example, the second furniture component 14 may be retrofit to include the first furniture component 12. To do so, material from the second side 18 of the second furniture component 14 is removed to form the cavity 20. In some embodiments, removing the material from the second side 18 of the second furniture component 14 includes milling the material from the second side 18 of the second furniture component 14. The first furniture component 12 is inserted into the cavity 20 of the second furniture component 14. Then, at least one layer of molten material is deposited on top of the second side 18 of the second furniture component 14 and the first furniture component 12. The at least one layer of molten material may be deposited on an entirety of the first furniture component 12 to encapsulate the first furniture component 12, or the at least one layer of molten material may be deposited on a perimeter or a portion of the first furniture component 12 to capture the first furniture component 12. Such a method may be used to retrofit 3D printed second furniture components 14 created without the first furniture component 12. Additionally, such a method may also be used if the first furniture component 12 may not be easily inserted in and/or placed on the second furniture component 14 during the printing process. For example, if the first furniture component 12 is large, vulnerable to heat, and/or not sufficiently stiff, retrofitting the second furniture component 14 to include the first furniture component 12 may be useful.

Another method 200″ of three-dimensional (3D) printing a multi-component structure 10″ is shown in FIG. 5. Top-down views of the multi-component structure 10″ and sectional views of the multi-component structure 10″ during the steps of the method 200″ are shown in FIG. 5. In step 202″, a first furniture component 12″ is provided. Illustratively, the first furniture component 12″ is glass for a window frame (i.e., a second furniture component 14″). In step 204″, a print path for a nozzle of a printer to deposit at least one first layer of molten material on a print surface is set. In step 206″, the at least one first layer of molten material is deposited on the print surface. The at least one first layer of molten material forms a first side 16″ of the second furniture component 14″. Steps 204″ and 206″ may be repeated for as many layers as necessary to form a body 17″ of the second furniture component 14″.

In step 216″, the first furniture component 12″ is positioned on the body 17″ of the second furniture component 14″, as shown in FIG. 5. In some embodiments, the first furniture component 12″ is positioned on the body 17″ of the second furniture component 14″ by placing the first furniture component 12″ on top of the body 17″. In other embodiments, the first furniture component 12″ is positioned in a cavity formed in the body 17″ of the second furniture component 14″, as previously described in relation to methods 200, 200′. In step 218″, a print path for the nozzle to deposit at least one second layer of molten material is set. The print path is set so that the at least one second layer of molten material is deposited on a perimeter of the first furniture component 12″.

In step 220″, the at least one second layer of molten material is deposited onto the at least one first layer of molten material and the first furniture component 12″ while the at least one first layer of molten material is molten to form a second side 18″ of the second furniture component 14″. The at least one second layer of molten material bonds to the at least one first layer of molten material to hold the first furniture component 12″ in place. The at least one second layer of molten material covers the perimeter of the first furniture component 12″ such that the first furniture component 12″ is captured in the second furniture component 14″ by the at least one second layer of molten material. In step 222″, the layers of molten material are cooled to cause the layers of molten material to solidify and form the second furniture component 14″ having the first furniture component 12″ captured therein.

Another method 400 of three-dimensional (3D) printing a multi-component structure 310 is shown in FIG. 6. Top-down views of the multi-component structure 310 and sectional views of the multi-component structure 310 during the steps of the method 400 are shown in FIG. 6. In step 402, a first furniture component 312 is provided. The first furniture component 312 may comprise a placard or a sign, as shown in FIG. 6, a hook, or a holder, among other items. In some embodiments, the first furniture component 312 includes an external portion 325 and an embedded portion 327, as shown in FIG. 6.

The external portion 325 is configured to be external to a second furniture component 314, as shown in FIG. 6. In some embodiments, a surface of the external portion 325 facing the second furniture component 314 is formed to include ridges 326. The ridges 326 are configured to contact the second furniture component 314 and help to align the first furniture component 312 with the 3D printed second furniture component 314 during the printing of the second furniture component 314, as suggested in FIG. 6. In some embodiments, the ridges 326 are milled on the first furniture component 312.

The embedded portion 327 of the first furniture component 312 is configured to be embedded in the second furniture component 314, as shown in FIG. 6. In some embodiments, the embedded portion 327 is formed to include holes 328. The holes 328 help to increase a strength of the multi-component structure 310. Though shown as including a plurality of circular holes 328, the first furniture component 312 may be formed to include any shape or number of holes.

In step 404, a print path for the nozzle of the printer to deposit at least one first layer of molten material on the print surface is set. In step 406, the at least one first layer of molten material is deposited on the print surface. The at least one first layer of molten material forms a first side 316 of a second furniture component 314. In step 408, a print path for the nozzle to deposit at least one second layer of molten material on the at least one first layer is set. In step 410, the at least one second layer of molten material is deposited on the at least one first layer of molten material while the at least one first layer of molten material is molten. The at least one second layer of molten material forms a portion of a body 317 of the second furniture component 314.

In step 412, a print path for the nozzle to deposit at least one third layer of molten material on the at least one second layer is set. In step 414, the at least one third layer of molten material is deposited on the at least one second layer. The at least one third layer of molten material forms another portion of the body 317 of the second furniture component 314. Steps 412 and 414 may be omitted or steps 412 and 414 may be repeated depending on the number of layers needed to form the body 317 of the second furniture component 314.

In step 416, the first furniture component 312 is positioned on the body 317 of the second furniture component 314, as shown in FIG. 6. The embedded portion 327 is positioned on top of the body 317 of the second furniture component 314, and the external portion 325 is positioned adjacent and contacting the second furniture component 314. The ridges 326 of the external portion 325 of the first furniture component 312 are aligned with each of the layers of molten material.

In step 418, a print path for the nozzle to deposit at least one fourth layer of molten material is set. In step 420, the at least one fourth layer of molten material is deposited onto the at least one third layer of molten material and the first furniture component 312 while the at least one third layer of molten material is molten to form a second side 318 of the second furniture component 314. The at least one fourth layer of molten material bonds to the at least one third layer of molten material to hold the first furniture component 312 in place. The at least one fourth layer of molten material may flow through the holes 328 formed in the embedded portion 327 of the first furniture component 312 to bond to the at least one third layer of molten material below the embedded portion 327.

In step 422, the layers of molten material are cooled to cause the layers of molten material to solidify and form the second furniture component 314 having the first furniture component 312 captured and/or partially embedded therein, as shown in FIG. 6. Method 400 may be advantageously used to partially embed, for example, a coat hook in a chair, a table, or an office pod as a portion of the coat hook may be located external to the second furniture component 314.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A method of three-dimensional (3D) printing multi-component furniture, the method comprising
providing a first furniture component,
depositing at least one first layer of molten material on a print surface to form a first side of a second furniture component,
depositing at least one second layer of molten material onto the at least one first layer of molten material while the at least one first layer of molten material is molten to form a body of the second furniture component having a cavity,
inserting the first furniture component into the cavity of the second furniture component,
depositing at least one third layer of molten material onto the at least one second layer of molten material and the first furniture component while the at least one second layer of molten material is molten to form a second side of the second furniture component, and
cooling the at least one first layer of molten material, the at least one second layer of molten material, and the at least one third layer of molten material to cause the at least one first layer of molten material, the at least one second layer of molten material, and the at least one third layer of molten material to solidify and form the second furniture component having the first furniture component at least partially encapsulated therein.

2. The method of claim 1, wherein depositing at least one third layer of molten material onto the at least one second layer of molten material and the first furniture component includes depositing the at least one third layer of molten material on a perimeter of the first furniture component so that the first furniture component is captured in the second furniture component by the at least one third layer of molten material and at least a portion of the first furniture component is accessible from an exterior of the second furniture component.

3. The method of claim 1, wherein depositing at least one third layer of molten material onto the at least one second layer of molten material and the first furniture component includes depositing the at least one third layer of molten material on an entirety of the first furniture component so that the first furniture component is entirely encapsulated in the second furniture component by the at least one third layer of molten material.

4. The method of claim 3, wherein the first furniture component is not accessible from an exterior of the second furniture component.

5. The method of claim 3, further comprising, after the step of cooling, removing material from the second side of the second furniture component located above the first furniture component to form an opening in the second side of the second furniture component so that the first furniture component is accessible from an exterior of the second furniture component.

6. The method of claim 5, wherein removing material from the second side of the second furniture component includes milling the material from the second side of the second furniture component.

7. The method of claim 1, further comprising providing a metal plate configured to be embedded or captured in the second furniture component.

8. The method of claim 7, further comprising, after the step of depositing at least one first layer of molten material on a print surface and before the step of depositing at least one second layer of molten material onto the at least one first layer of molten material, locating the metal plate on the at least one first layer of molten material and depositing at least one fourth layer of molten material on the at least one first layer of molten material and the metal plate.

9. The method of claim 8, further comprising, after the step of cooling, heating the metal plate to cause the solidified at least one third layer of molten material and the solidified at least one fourth layer of molten material located on the metal plate to become molten.

10. The method of claim 9, further comprising removing the metal plate and the first furniture component from the second furniture component.

11. The method of claim 1, wherein the first furniture component includes an RFID chip or a NFC chip.

12. The method of claim 1, wherein the first furniture component includes a sensor.

13. The method of claim 1, further comprising 3D printing the first furniture component.

14. A method of three-dimensional (3D) printing a multi-component structure, the method comprising
providing a first component,
depositing at least one first layer of molten material to form a first side of a second component,
depositing at least one second layer of molten material onto the at least one first layer of molten material while the at least one first layer of molten material is molten to form a body of the second component,
positioning the first component on the second component,
depositing at least one third layer of molten material onto the first component while the at least one second layer of molten material is molten to form a second side of the second component, and
cooling the at least one first layer of molten material, the at least one second layer of molten material, and the at least one third layer of molten material to cause the at least one first layer of molten material, the at least one second layer of molten material, and the at least one third layer of molten material to solidify and form the second component having the first component at least partially embedded therein.

15. The method of claim 14, wherein positioning the first component on the second component includes positioning an embedded portion of the first component on top of the body of the second component and positioning an external portion of the first component adjacent to the body of the second component.

16. The method of claim 15, wherein depositing at least one third layer of molten material onto the first component includes directing the at least one third layer of molten material through at least one hole formed in the embedded portion of the first component.

17. The method of claim 15, wherein the external portion of the first component is formed to include a plurality of ridges that align with the first layer of molten material and the second layer of molten material.

18. A three-dimensional (3D) printed multi-component structure, the multi-component structure comprising
a first component,
a second component having a first side and a second side opposite the first side, the second component being formed to define a cavity that extends into the second component from the second side toward the first side,
wherein the second component is 3D printed and the first component is located in the cavity of the second component to at least partially embed the first component in the second component.

19. The multi-component structure of claim 18, wherein the first component is entirely encapsulated in the second component.

20. The multi-component structure of claim 18, wherein the first component comprises a RFID chip, a NFC chip, or a sensor.
